(19) United States
(12) Patent Application Publication
(10) Pub. No.: US 2003/0172513 A1
(43) Pub. Date: Sep. 18, 2003

(54) Pipe joining method

(76) Inventor: Norio Takei, Hyogo (JP)

Correspondence Address: Adams & Wilks, 31st Floor, 50 Broadway, New York, NY, 10004, US

(21) Appl. No.: 10/344,198

(22) PCT Filed: Aug. 8, 2001
(86) PCT No.: PCT/JP01/06808

(30) Foreign Application Priority Data
Aug. 8, 2000 (JP) 2000-240251

(51) Int. Cl. B23P 19/02

(52) U.S. Cl. 29/426.4; 29/469.5

(57) ABSTRACT

A method which, in attaching a stiffening ring (3b), a lock ring (11), and a stop ring (15) to the outer surfaces of steel pipes, corrects peaking which occurs in the pipe joint and these rings; a method which, in attaching a joint ring (2) to the inner surface of a steel pipe, correct speaking which occurs in the joint ring (2), a method of producing a stiffening ring (3a) utilized in the above-mentioned joint; a construction for a packing (6) used in the joint; a method of laying steel pipes having the joint; and a seal surface construction for the joint. According to the pipe joint thus produced, manufacture of pipe joints in a factory can be unmanned and the field operation can be simplified.

### TECHNICAL FIELD

The present invention relates to a joint used for a various kind of steel pipes for pipelines such as irrigation pipes, pipes for hydroelectric power generation (water-pressured iron pipes), pipes for transporting slurry such as gravel, coal and dirt, pipes for service water or sewage, capsule transportation pipes and so forth. The joint according to the invention can be connected instantaneously only by press fitting using jacks. The joint is fixed to an end portion of a steel pipe in a factory. Several hundreds steel pipes are placed straight at a construction site. Wire-traction jacks are used for simultaneous press fitting to make a high-speed construction possible. The joint is further expansible and flexible. Even if ground displacements occur on earthquakes, many joints can expand to absorb the displacements and prevent the pipeline to be destructed. The end portion of the steel pipe is automatically worked in a fully automated factory for attachment to the joint.

### BACKGROUND ART

The conventional method for joining a plurality of steel pipes to construct a pipeline is based on a method in which the steel pipes are welded. This method has its own advantage in that it does not allow fluid leakage even under high pressure, but disadvantageously it takes long hours and special expertise for the testing of the welded portions of the pipes. The welded portions, furthermore, lack enough expandability and flexibility and, when great earthquakes occur, they have often been found disassembled at portions to which the welding heat is applied and which are sensitive to impact. Ductile iron pipes; Spigot and socket pipes in ISO 2531 are able to be joined only by press fitting using jacks, and the joining work requires no expert labor and can be completed in a short period of time. However, the rubber packing need to be renewed every five to ten years because of its aging. The rubber packing will otherwise invite leakage at internal pressures as high as 15 Kgf/cm². The renewal work for the packing demands a great deal of construction costs and an unexpectedly long period of time. Since earlier rubber deterioration is actually anticipated, these pipes are used only for city water where leakage is allowed even under a low pressure of 3 Kgf/cm². However, the water leaking from the ductile iron pipes of approximately 40 years in service is found to cause a serious problem. The leaking city water in a dry land causes the level of ground water to rise, and salt contained in the deeper section of the ground is brought onto the ground surface together with the ground water and stays there even after the water gets evaporated. This causes salt accumulation and destroys plants and trees, also corroding iron constructions.

To solve the problems, the present inventor filed a patent application, which was patented on Nov. 8, 1995 as Japanese Patent No.1986144 and on Jul. 7, 1992 as U.S. Patent “PIPE JOINT STRUCTURE”, U.S. Pat. No. 5,127,680. The present invention relates to an improvement for this technique, which enables mass-production in fully automated factories and meets the demand of customers and technical trends. Today, drought and desertification occur in all parts of the world by global warming. Many projects to transport water from rainy zones full of water to arid zones over watersheds are going on in various countries, but most of them are not yet realized because such projects require an enormous budget with big interest costs and a very long construction period, and thus beneficial burdens tend to be too heavy.

For example, a project to transport water from Canada to US was planned in 1980's. According to the plan, many dams are constructed at five big rivers in the northwest areas of Canada and 140 billion tons of water per year are transported to the arid zones of north America through aqua-tunnels over watersheds using seventeen conduits as long as 20,000 km. A consulting company estimated that it takes 30 years for construction work, needing 350 billion dollars. Particularly, a term of construction work as long as 30 years produces enormous interest costs, amounting to ten times costs with a rate of 1.08 (10=(1.08)⁻30). This burdens beneficiaries too heavily.

If irrigation channels or canals are used as aqueducts, 60% of water evaporates into the atmosphere and penetrates into the soil. The penetrated water into the soil causes the level of ground water to rise in the vicinity of the channels or canals, and also causes salt existing deeply in the soil to rise up to the ground surface and to be accumulated there. The salt in the soil might be dissolved into the irrigation water and condensed there. The use of such water for irrigation causes plants to absorb only the water and salt to be left. If the salt concentration exceeds 1500ppm, plants are damaged by salt and cannot grow at all. This is called salt damages. To prevent the salt damages, the salt water should be leached. LR (Leaching Requirement) increases abruptly by the concentration of salt in the irrigation water. The water used for the leaching should be drained by means such as a culvert to prevent the ground water level from rising. This needs enormous costs for the leaching process and its equipments. Furthermore, long distance aqueducts are necessary for canal or channel irrigation because they must be elongated over watersheds. This necessitates enormous costs and a very long period of construction work. The irrigation channel or canal would grow water grass, which might propagate shellfishes living there and spread diseases (human blood fluke) to inhabitants with the number of the infected people already amounting to 20 millions now.

To solve this problem, the irrigation using steel pipes can be substituted for the channel or canal irrigation, but the employment of steel pipes brings about a major drawback in turn. Much water must be transported in the distance at high pressures and high speeds using steel pipes having an outer diameter of 3 meters. It takes 30 hours for the 3 m diameter steel pipes capable of withstanding high pressures to be joined by welding and its welded portions to be inspected. This increases the budget and extends the construction period very much. The inspection cost is the biggest problem for irrigation in the irrigation zones.

Natural energy development is very important for mankind. The hydroelectric power generation is the cheapest one of natural energy resources, but it requires a large scaled dam site sacrificing fertile agricultural lands or forests. The artificial lake created by the dam accumulates a large pile of earth and sand, reducing its reservoir. And eventually economical merits of the dam are gradually lost in the long run. Furthermore, the dam cuts off the food chain because it obstructs organic matters with migratory fishes obstructed from coming up. Such an environmental destruction causes environmentalist groups to oppose the dam development project so harshly that many dam projects tend to be deadlocked now.

In order to solve the problems, the inventor filed a Japanese patent application “Method of dam construction and method of hydroelectric power generation” (Filing number 2000-26560), wherein it is proposed that earth and sand as well as organic matters flowing into the dam are sucked and discharged actively using conduit pipes. In these methods, the pipes tend to be worn out easily, and they must be provided with a continuous lining all over the inner surface. The pipe with the lining undergoes frictional forces caused by gravels and pebbles flowing against the pipe wall. In order to withstand the friction acting on the pipe wall, the pipeline should be strong enough to withstand it not only at flanged portions at its end, but at joint portions of the pipes, requiring improvements in pipe joint structure.

In order to generate ten times as much as hydroelectric power with the water fall maximized, a dam is constructed upstream of a water system and a power plant at the foot of the mountain with smaller scaled dams constructed therebetween. In this design, the pipeline of 3 m great outer diameter aqueducts would be one hundred times longer than that of the conventional water-pressured iron pipes. If all the drawbacks of the conventional welded joints can be overcome, the total power generation cost could be reduced drastically.

If other drawbacks of the weld joint for the steel pipes can also be dissolved, all the projects once thought almost impossible due to their low profitableness can be changed into highly profitable ones. For instance, coal is carbonized, desulfurized,microbiologically at low cost and transported using a low-cost slurry pipeline. The second Panama canal, or Isthmus canal in Malay Peninsula might be realized at very low cost, or sludge accumulated in a closed gulf such as Tokyo bay can easily be drained to the open sea, so that such gulfs or bays are cleaned up as in old days, and, at the same time, the open sea turns into richly nourished fishery.

The pipeline for these purposes is exposed to abrasive fluid, but the technologies already applied for patent or patented by the present inventor can be combined in the present invention to solve all the problems caused by the abrasive fluid. The technologies include: “LINE-PIPE WITH LAMINATED LINING INCLUDING ADHESIVE LAYER AND ITS OPERATION METHOD” (1698219); “LINING LAMINATE FOR A PIPELINE” (U.S. Pat. No. 4,962,958); and “A LINING LAMINATE FOR A PIPELINE AND OPERATION METHOD THEREOF” (EU British patent EP0344 896 B1, and Chinese patent No. 14815). The patent application further includes “LINING STRUCTURE AND ITS DETACHING METHOD” (Japanese patent application H11-89058).

Thus, the present invention can create an enormous demand.

### DISCLOSURE OF THE INVENTION

To meet enormous demands, the present invention improves the patents that the present inventor owns. The joint working for steel pipe end portions is effected in a fully automated factory for mass production. For this purpose, the present invention makes use of high technologies including industrial robots, CNC machine tools, computer controlling systems, FA systems, TBM (Time Based Maintenance), and CBM (Condition Based Maintenance) technologies, etc. The factory can be operated throughout the day and throughout the year without human operations. The present invention can simplify the on-site joint job so that inexperienced workers can easily perform it. Thus, the present invention can create many chances of employment even for workers from the poorest group in developing countries, and help them to escape from poverty. Major improvements are as follows:

(1) Stiffening rings 3a and 3b, a stop ring 15 and a lock ring 11 are provided around the outer periphery at ends of steel pipes. Flat steel and square bar are precisely cut so that their length may be made equal to the outer peripheral length of the pipe to which these rings are attached, and they are bent using a bending roller. The flat steel and square bar are difficult to be bent at both ends thereof, so that end bending is used in which these portions are previously bent with a curvature smaller than the bending curvature. This indeed shortens the portions for which the bending doesn't work, but no complete correction is impossible. If the incomplete portions are welded and joined, they form a peak. This is called peaking. The cutting for the inner and outer diameters at the peaking portions causes pipe thickness to vary greatly at the peaking portions with the result of reduction in joint strength. To avoid this, peaking is corrected as follows and the pipe is cut at the inside and outside diameter portions. As shown in FIG. 6, peaking occurs on the periphery of the welded portion of the steel pipe and the butt portion of the ring. A press with a given radius of curvature is used for end bending to correct peaking and the steel plate is then bent in conformance to the outside diameter of the pipe. However, the steel plate remains unbent at end portions thereof with the result that peaking is not sufficiently corrected. The steel plate of rings that are set on the outer periphery of the steel pipe also undergoes end bending previously using a press with a small radius of curvature and it is bent into a predetermined inside diameter. The ring is set at a predetermined position with the welded portion of the steel pipe downside and the butt portion of the ring upside as shown in FIG. 7. At that time, the ring is not still welded at its butt portion and can be set with ease at a predetermined position. The ring butt portion is then welded to fix the ring. Gaps appear due to peaking as shown in FIG. 7 near the welded butt portions of the steel pipe and the ring. This causes circularity to be reduced. To remove gaps for improvement in circularity, a mechanical jack (hydraulics acceptable) is inserted into the inner surface of the steel pipe to expand the pipe. The ring is also expanded to such an extent as not to exceed elastic limit. The pipe is rotated with the pipe-expanding force maintained and downward fillet welding is effected to fix the steel pipe and the ring together. The pipe-expanding force of the jack is made zero when the temperature of the welded portion becomes lower than a certain threshold. Peaking is thus corrected. When the jack is used to expand the pipe, the rings are made of high tensile steel so as not to cause any plastic deformation.

(2) A joint ring 2 is made of super high tensile steel as great as 1500 MPa and it requires as high precision as possible in outer diameter. This is because a small dispersion of press fitting forces on the joint ring is preferable when several hundreds joint pipes are press fitted at once. The joint ring is manufactured according to the next processes:

[1] Hot rolled flat steel of a predetermined width (usually 110 mm) and a predetermined thickness (calculated based on the inner pressure) is prepared and cut precisely to the circumferential length of the ring with its cut surface being beveled to provide groove. The steel is subjected to end bending, rolled to form a ring and welded at its butt portion.

[2] The ring is quenched in a continuous heat treatment furnace and tempered to strength of 1500 MPa.

[3] Several tens joint rings are set on a cylindrical pipe-expanding jack and expanded until peaking on the welded butt portion of the ring disappears. The CNC polishing machine is used with the pipe-expanding force kept and the ring is finished with high precision with its diameter made to a predetermined one. Before expanding the ring, a stress-strain gage is provided to precisely measure a change in stress-strain before and after expanding in order to correct the outer diameter by a change in strain using the abrasive polishing.

[4] The joint ring is inserted into the cut portion on the inner end surface of the pipe 1a. The pipe is previously made free from peaking when the stop ring 15 and the lock ring 11 are set thereon. This is because, if the inner surface is cut with peaking remaining at the welded portion of the steel pipe 1a, the thickness varies greatly after cutting and this reduces the sealing capability of the joint and its strength. The inner surface of the pipe 1a is cut with high precision using a CNC machine tool with the inner diameter of the cut portion made 0.2% smaller than the outer diameter of the joint ring. The pipe-expanding jack is then inserted into the end of the pipe 1a to expand the pipe end more than 0.2% and the joint ring is inserted into the cut portion. After insertion the pipe-expanding force of the jack is made zero. The inserted portion of the joint ring then undergoes compressive strain as great as 0.1 to 0.2%. The joint ring is then fixed, by welding, to the steel pipe 1a at two portions as shown in FIG. 1. High tensile steel is used for the lock ring 11 so as not to undergo plastic deformation when the pipe is expanded more than 0.2%.

(3) The stiffening ring 3a is manufactured and attached to the pipe 1b as follows:

[1] Hot rolled flat steel made of high tensile steel is cut to be 500 mm wide and 9 mm thick so as to be equal to its circumferential length with its cut surface being beveled to provide groove.

[2] Gas cutting is used to provide notches 13 as long as the claws 10.

[3] After end bending, the steel is roll bent with its outer diameter made slightly smaller than that of the stiffening ring.

[4] A bend jig 12 (see FIG. 8) is used to bend the claw 10 inwardly at 60 degrees with a press at once with the help of transfer press in a plurality of bending processes. The claw with the bending work completed is rotated in the circumferential direction of the bend jig.

[5] The stiffening ring 3a is set on a predetermined position of the stiffening ring 3b with its butt portion to be welded upside. The butt portion to be welded deviates 90 degrees from that of the stiffening ring 3b. Then the stiffening ring is butt welded. The stiffening rings 3a and 3b undergo downward fillet welding with the pipe rotated in order to fix them together.

(4) The joint according to the present invention is almost used in combination with a continuous lining method that the inventor proposed. This is because the service life of the pipeline should be perpetual even if excessively abrasive fluid flows therethrough. The lining manufactured in the continuous lining method can be found worn in early stages and replaced in a short time without damages of the pipeline itself and with its service life made eternal. The lining is loaded with great frictional forces from the abrasive fluid. To withstand this, a reinforcement sheet is provided around the periphery of the lining in the continuous lining method. The reinforcement sheet is effective at a flange portion at an end of one work section. However, it is insufficient, so that the joint of the invention is used for this purpose. A nylon packing 6 of fine fiber is provided with countless projections at its tip to form a sheet fastener 6a with its projections biting into the fiber of the reinforcement sheet. The sheet fastener exhibits strong shearing stresses relative to axial forces, but can be pulled off by weak force when it is pulled perpendicularly relative to the sheet direction. This feature is used for replacement of the worn lining. Upon replacement, forces acting perpendicularly on the sheet fastener are applied to the lining, which can then be pulled off easily with the replacement completed in a short time. The frictional forces of the fluid acting on the pipe wall determine the length L of the sheet fastener. The nylon packing with the sheet fastener is attached to the end portion of the pipe using a double-sided adhesive sheet 5 that is attached to the inner surface of the pipe end portion. The nylon packing with the sheet fastener is then attached to the other surface of the adhesive sheet. The nylon packing is covered with grease of high viscosity adjusted to such a level that the grease doesn't drop off even at high temperatures during transportation and at a construction site. The pipe is also sprayed with anticorrosive oil at its whole surface. The steel pipes are then sealed at their ends as follows for prevention from sand und dust. A 2 mm thick polyethylene sleeve 9 having an inside diameter sufficiently as large as the outer diameter of the stiffening ring 3a is disposed with its tip protruding forwardly from the end of the stiffening ring 3b. The protruding portion is fixed to the steel pipe 1b by a gum tape or a tie 8. The other end of the polyethylene sleeve elongates from the end of the stiffening ring 3a so long as to be able to close its opening. The protruding portion is then tied to close the opening of the stiffening ring 3a. A sheet suitable to the joint ring is provided to seal the pipe end on the side of the joint ring 2.

(5) The pipeline is constructed at a site as follows. The pipeline includes straight portions, curved portions with centrifugal forces from fluid acting thereon and valves with inner pressures acting thereon. Since the forces from the fluid acting on the latter are great, an anchor block is provided on the ground to withstand them. The straight portions only undergo the frictional forces of the fluid against the pipe wall, which are smaller than the forces acting on the curved portions, so that frictional forces between the pipeline and the ground are used to support the straight portions. The straight portion of the pipeline determines one work section in which the anchor block is provided to withstand the forces from fluid. In this one work section, several hundreds to several thousands steel pipes are arranged straight without limit whatever it may be as long as several kilometers.

[1] A plurality of rollers 16 with a built-in jack as illustrated in FIG. 4 are placed under a buried or built pipeline. The rollers are spaced at an interval equal to the standard length of a pipe (which is typically 5 to 6 meters). The roller is adjusted so that it is positioned at the middle of the steel pipe after press fitting of the pipes. A pit 17 is dug at the construction site in such a way that the rollers are placed with their top ends aligned straight. Sand 18 for adjusting the height of the rollers is prepared and added or removed to adjust the highest portions of the rollers to be aligned straight. The roller top must be 80 mm high from the ground level 19 when the jack is fully up; the roller top must come lower than the ground level when the jack is down.

[2] Just before the pipes are arranged on the rollers, the sheet that covers the mouth of the joint ring is removed. The polyethylene sleeve that closes the stiffening ring 3a is untied. The steel pipes are then brought into slight contact with each other as shown in FIG. 2 and covered with the polyethylene sleeve up to the stop ring 15 so as to prevent the joined portions from suffering from dust. The sleeve is temporarily tied.

[3] In order to simultaneously press-fit and join a multiple of pipes using wire-traction jacks, the first step is to fix an end of the wire 21a to the anchor block installed at one end of the work section. The wire-traction jacks 22 are then placed at the stop ring 15 of the last pipe of the straight arranged steel pipes. The traction wire 21b fixed to the jack 22 is connected with the wire 21a that is fixed to the anchor block at one end. The traction of one jack is five tons and the traction speed is 0.5 m per minute. The number of jacks must be large enough to successfully complete the press fitting, and they are placed symmetrically relative to the traction direction. It becomes problematic if one of jacks works too fast or too slowly because this may destroy the balance. To prevent this, a hydraulic power unit is provided with an automatic balancer to suppress oil for a fast-working jack and increase it for a less-working one. This ensures automatic balancing. The press fitting by the jacks is complete when an expansion or contraction gap C becomes zero. The press fitting per joint measures 120 mm. In the case where four hundred pipes (each of which is 5.3 m long) are aligned straight, the time required for the entire work of press fitting these pipes is estimated to be 0.12×(400−1)/0.5=96 (minutes). The total length of a line with the steel pipes each 5.3 m long is 5.3×400=2120 m. The press fitting of the pipes stretching 2.12 kilometers long can be completed in 96 minutes or 1.6 hours. This means a construction speed of 2.12/1.6=1.3 Km/hour. And if the work is done round the clock in three rotational shifts, the output would be 1.3×24=31 km/day. Conventionally, it takes approximately 30 hours per joint for weld joining of the 3 m outer diameter steel pipes, whereas the 400 hundred steel pipes can be joined in 96 minutes according to the invention with the average joining time per joint 96×60/400=14.4 (seconds).

[4] It is detected whether the expansion or contraction gap C between the jointed pipes becomes zero after press fitting. Since the expansion or contraction gap is not visible from the outside of the pipes, a gap Ca is used instead because the stop ring 15 is positioned in such a way that the gap C is made equal to the gap Ca between the stop ring 15 and the stiffening ring 3a. The temporarily tied polyethylene sleeve is strongly tied using the gum tape and the tie 8 to seal the joint with the gap Ca made zero.

[5] The jack-built-in rollers 16 are lowered to land the press fitted pipes onto the ground 19 when the pipeline is estimated to have expanded at maximum capacity with the solar heat. After that, the sand 18 placed under the jack-built-in rollers is removed and a roller recalling wire 23 is used to pull up the rollers. The jack-built-in rollers are ideally made of light alloy so that the rollers are transportable with muscular energy.

[6] The pipeline is then buried underground and water is flowed inside. This causes the steel pipes to be cooled up to the water temperature and contracted with the expansion or contraction gap kept at an appropriate length. To calculate the gap, it is assumed that a rated pipe length is 6 m; the temperature of the heated pipeline is raised to 80° C.; and the temperature of the flow water is 20° C. When the temperature of the steel pipe is dropped to 60° C., the contraction of a 6 m pipe would be 4.32 mm, given the coefficient of linear thermal expansion of steel being 1.2×10⁻⁵/° C. This means that the expansion or contraction gap reaches 4.32 mm. The maximum of expansion or contraction gap in the pipe joint of the present invention is 35 mm. The gap corresponding to the difference of 35−4.32=30.68 mm is reserved for absorbing ground displacement at the time of earthquakes. In the case where hot water is caused to flow through the pipes, the thermal expansion of the pipes is calculated based on the difference between the temperature upon construction and the temperature of hot water. A spacer having a thickness equal to the calculated length is placed before press fitting between the stop ring 15 and the stiffening ring 3a, and is removed after press fitting to keep the expansion or contraction gap suitable.

(6) A spread method is used to construct the pipeline with high efficiencies. Prior to the press fitting of the joint, it needs some preparations such as installation of jack-built-in rollers, alignment of pipes, setting of wire-traction jacks and so on. Post processes are such as visual confirmation of pipe press-fitting; sealing of the joints by the polyethylene sleeve; landing of the pipeline; removal of the wire traction jacks; and recalling of jack-built-in rollers. Workers and equipments are arranged to complete all the processes at an efficiency corresponding to the working speed of press fitting of 1.3 km every hour. If workers belonging to one work section have completed the assigned task, they move to the next section and finish their assigned jobs. This allows a pipeline construction to proceed rapidly with an efficiency of 1.3 km per hour.

(7) A 12 m long space is kept between the work sections, where the pipeline is curved and the anchor block is installed to withstand centrifugal forces acting on the curved portion thereof. The lining is applied using a continuous lining method directly after the pipeline is constructed. The space is also necessary for this work. A 12 m long flexible pipe produced at a factory according to the following method is installed at the 12 m long space after the lining is completed by the continuous lining method. The joint according to the present invention is flexible and the pipe's maximum expansion or contraction is 35 mm for a 3 m outer diameter pipe, so that one joint can only be bent with an angular displacement of 0.67°. For a 1 m outer diameter pipe, the joint undergoes an angular displacement of 2°, which is also small. Twelve 1 m long pipes are prepared with each provided with the joint according to the present invention and press-fitted into a 12 m long flexible pipe with flange joints at both ends and with the lining provided on its inner surface. The flexible pipe is manufactured at the factory and brought to the site, where it is installed at the 12 m long space between the work sections.

The conventional types of curved pipes all require a high machining cost and many curved pipes are used which have a radius of curvature approximately twice as large as the pipe's outside diameter D. When the flow runs at a great speed through the curved pipes whose radius of curvature is small, there usually arise drawbacks such as great pressure loss and local abrasion inside the pipes. For the abrasive fluid to flow at a great speed, it is said that a radius of curvature has to be more than 25 times as large as the outside diameter D of the pipe. The bendable pipe comprised of short pipes (1 m) meets the above-mentioned requirement with the pressure loss reduced even if the fluid flows at high speeds.

(8) The seal portion 4 has its central inside diameter made smaller than that on the entrance and exit sides with a compressive strain of 0.2 percent acting on the joint ring 2 at the middle of the seal portion 4 and compressive strains on the entrance and exit sides made smaller than 0.2 percent. The joint according to the invention is slightly flexible and displaceable angularly. No compressive strain exceeding 0.2 percent acts on any portion of the joint ring even for maximum angular displacement. Taking this into account, the seal portion is worked so as to have a curve with an appropriate radius of curvature. If the seal portion is not curved, but made flat, excessive strains arise on the entrance or exit, causing plastic deformation and unnecessary bending moment on the joint ring.

### BRIEF DESCRIPTION OF DRAWINGS

FIG. 1 is an illustrative view showing the self-sealing mechanism of a steel pipe joint of the invention;

FIG. 2 an illustrative view showing an arrangement in which the pipes are brought into slight joining before press fitting of the steel pipe joint with the joined portion covered with a polyethylene sleeve to prevent it from being made dirty by earth and dust;

FIG. 3 is an illustrative view showing a state in which the expansion or contraction gap is close to its maximum directly after the pipe joint is press-fitted.

FIG. 4 is an illustrative view showing an arrangement in which the steel pipes are placed on jack-built-in rollers;

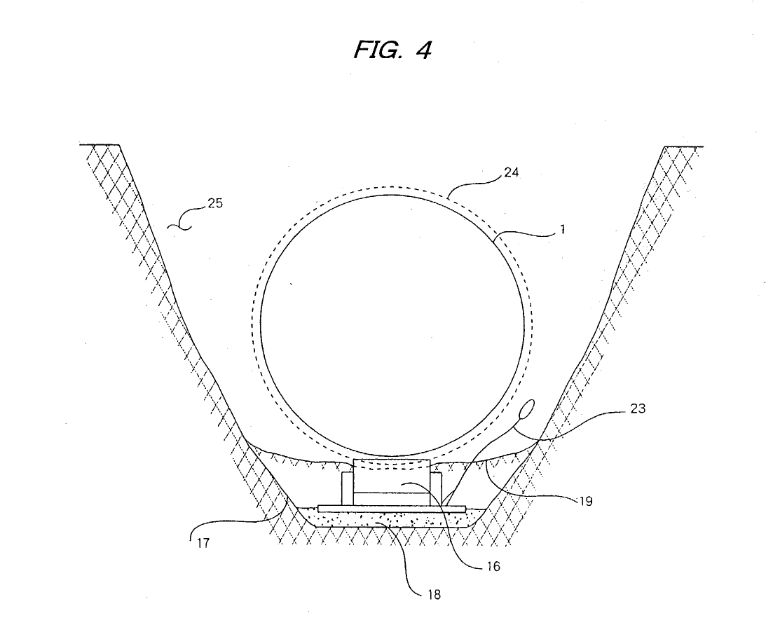

FIG. 5 is an illustrative view showing that a wire-traction jack is placed at the end of the last of the pipes with the tip of the wire fixed to an anchor block, the wire being pulled up until the joint is press-fitted;

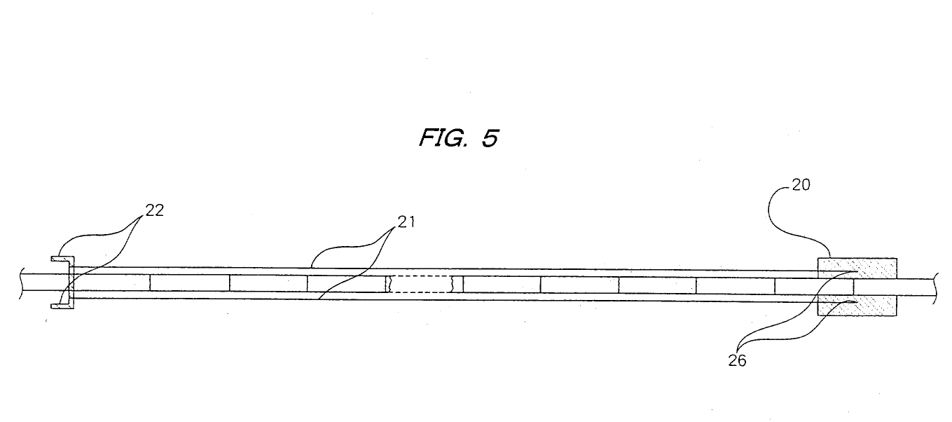

FIG. 6 is an illustrative view showing peaking on the steel pipe;

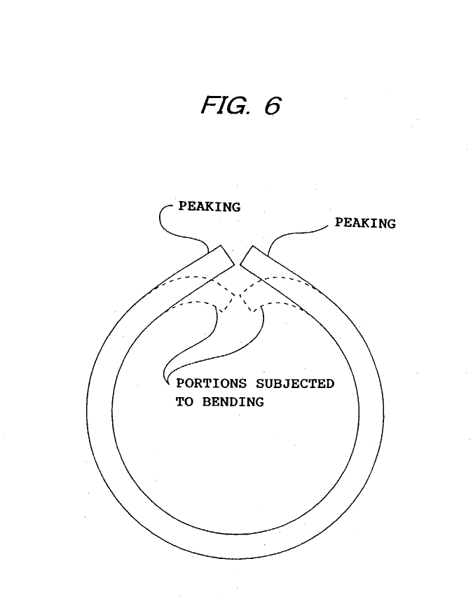

FIG. 7 is an illustrative view showing a method for correcting peaking on a ring; and

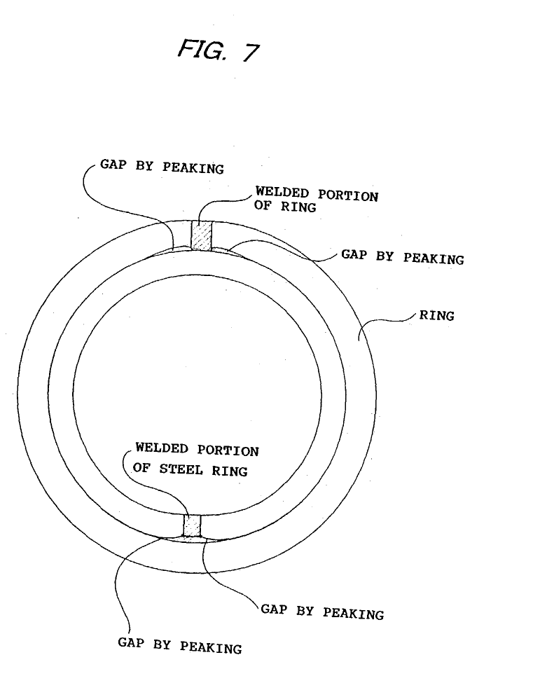

FIG. 8 is an illustrative view showing a method for bending the claws of a stiffening ring.

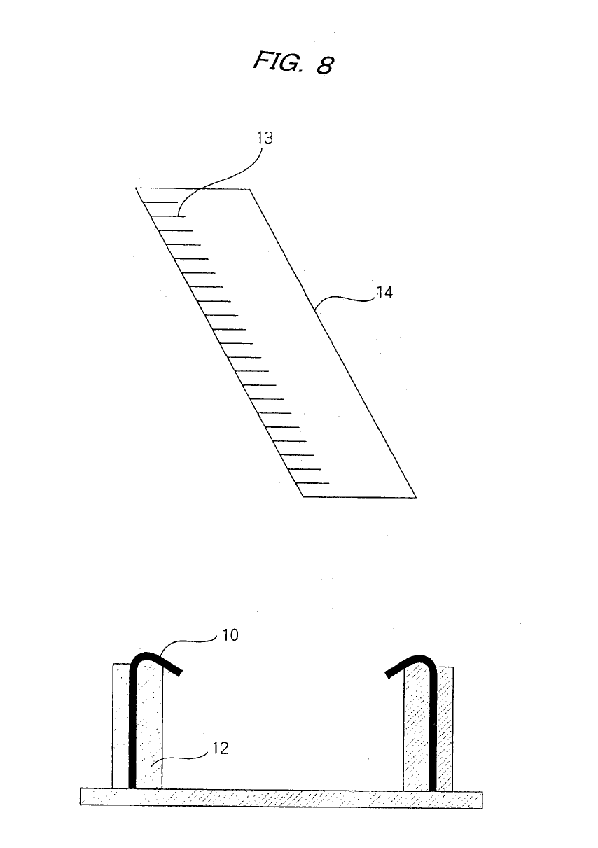

### REFERENCE NUMBERS

1a and 1b: pipe wall of the steel pipe

2: joint ring made of ultra high tensile steel

3a and 3b: stiffening ring

4: convex surface of the seal portion

5: double-sided adhesive sheet

6: nylon cloth packing

6a: sheet fastener with countless fine projections

7: lubricating grease

8: tie and gum tape for tying the polyethylene sleeve

9: polyethylene sleeve

10: claw

11: lock ring

12: tool for bending the claw

13: notch by gas cut

14: flat steel for the stiffening ring

15: stop ring

16: jack-built-in rollers

17: pit in which the rollers are placed

18: height adjusting sand

19: ground on which the steel pipes are installed

20: anchor block

21: wire of the wire-traction jack

22: wire-traction jack

23: wire for pulling up the roller

24; outer circumference of the stop ring and the stiffening ring 3a

25: ditch for burying pipes

26: portion to which the wire is fixed

C: expansion or contraction gap

Ca: gap between the stop ring and the stiffening ring 3a

L: length of the sheet fastener

Pw: inner pressure

Pr: reactive force against compressive strain on the joint ring

R: radius of curvature of the curved surface of the seal portion 4.

### BEST MODE FOR CARRY OUT THE INVENTION

The invention will be described in detail with reference to the accompanying drawings.

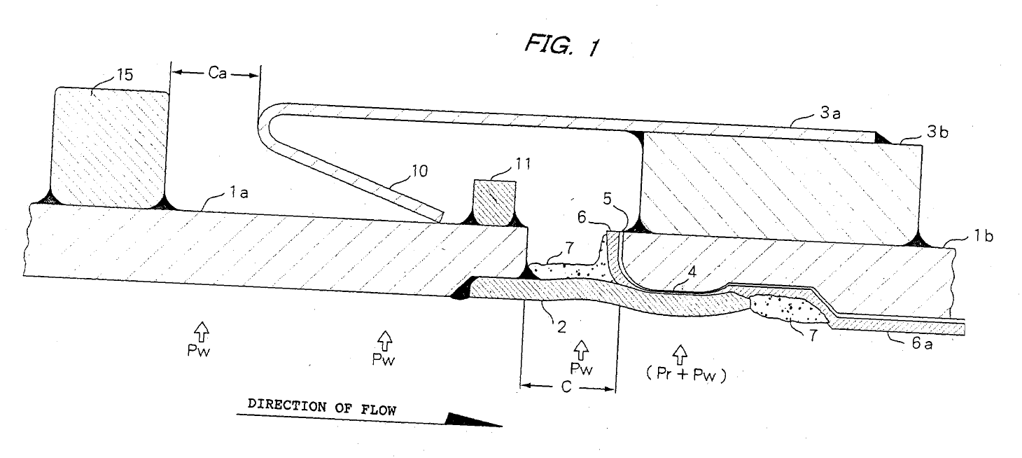

FIG. 1 is an illustrative view showing a self-sealing structure. A joint ring 2 is press-fitted and undergoes a compressive strain of approximately 0.2 percent with a reaction force Pr applied to a seal portion 4. The seal portion is pressed by an internal pressure Pw, and thus by a pressure of (Pr+Pw). Even if the internal pressure Pw become high, pressures bigger by Pr than the internal pressure are applied to the seal portion 4. This ensures that no leakage occurs.

When the steel pipe undergoes the internal pressure Pw, it expands about 0.1 percent in pipe diameter. Stiffening rings 3b and 3a are provided to suppress the expansion of the seal portion to be sufficiently smaller than the 0.1 percent expansion of the steel pipe itself even if it undergoes both the internal pressure Pw and the reacting force Pr of the joint ring.

A double-sided adhesive sheet 5 is used to adhesively fix a nylon-cloth packing 6 to the end portion of the pipe. The nylon-cloth packing is fully coated with lubricating grease of high viscosity. This converts the friction at the time of press fitting into a fluid friction and improves the sealing performance.

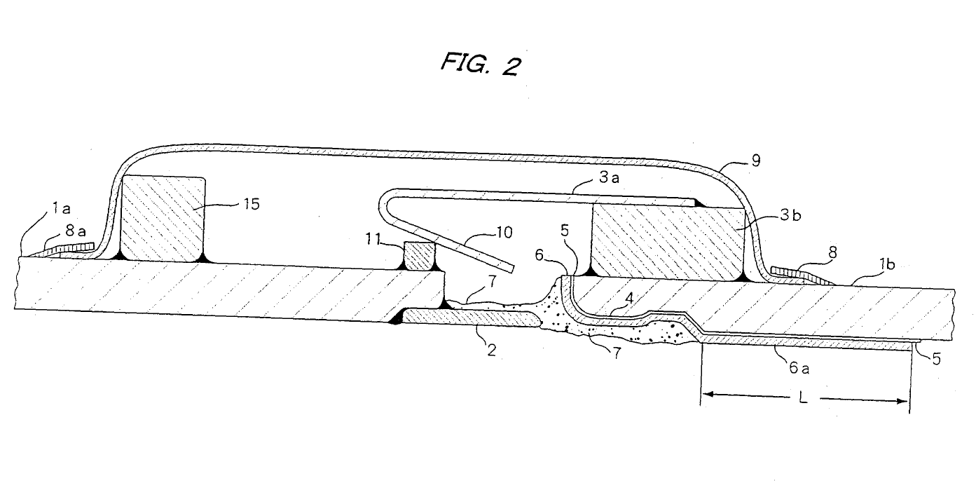

FIG. 2 shows a state where the steel pipes are aligned straight and brought into connection with a weak force. The steel pipes are covered with a polyethylene sleeve and a sheet at their end portions to prevent dust from coming into the pipes to contaminate the lubricating grease. These covers are removed from the pipes using a weak force directly before joining. The joined portion is covered with the polyethylene sleeve immediately after joining. The polyethylene is temporarily tied at the rear end of a stop ring 15 using a gum tape and a tie 8.

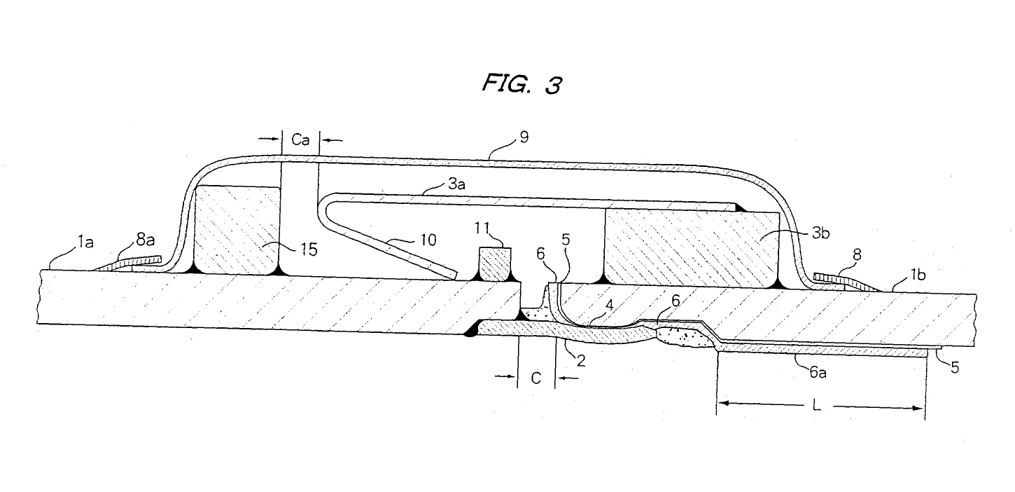

FIG. 3 shows a state directly after press fitting. The press fitting continues until the expansion or contraction gap C=Ca=0. The polyethylene sheet is untied for detection whether the gap Ca is zero the gum tape and the tie 8 are used for adhesive connection to the outer surface of the steel pipe. The steel pipes contract with the expansion or contraction gap Ca made greater after they are buried and water flows trough them. The expansion or contraction gap is also made great due to ground displacements upon earthquakes. The polyethylene sheet prevents the gap from being filled with earth and sand.

### INDUSTRIAL APPLICABILITY

The conventional method for weld-joining steel pipes having a large bore diameter as large as 3 meters in outer diameter requires 30 hours, but they are joined in 15 seconds in the invention. The present inventor also proposed a continuous lining method that enables the service life to be eternal even if abrasive fluid is caused to flow at high speeds. The features of the invention can be combined with the continuous lining method to provide two new technologies that would create the following huge demands.

(1) When the invention is applied to aqueducts used for hydroelectric power generation systems, soils and organic matters accumulated at the bottom of the dam lake can be discharged and the water storage can be maximized. Even a small dam will be able to generate three times electricity because for hydroelectric power generation it can utilize all the water stored in the dam at the time of a flood or a high water. The use of much longer aqueducts (nearly a hundred times longer than a normal one) allows the fall at the dam to be a few times longer, causing a possible output of generated energy to increase more than ten times because it is proportional to water amount multiplied by water fall. The working life span of the aqueduct is eternal and the reservoir capacity at the dam will be maintained good eternally with power generation costs remarkably reduced.

(2) It is common in the globe that a single region is divided into rainy and arid zones on the border of a watershed. A number of dams can be built at higher altitudes in the rainy zones to transport water through aqueducts directly under the watershed to the hydroelectric power stations in the arid zones for power generation and irrigation. As compared with the conventional aqueduct construction with pipes joint by welding, the construction period can be shortened to one tenth with the construction cost reduced to one fourth. This allows the working life span of aqueducts to be permanent and brings about a highly profitable business because water transportation and power generation can be done simultaneously.

(3) Coal is desulfurized by flue gas desulfurization only at large-scaled thermal electric power plants because of its huge capital investment. For this reason, coal is pulverized for carbonization at coal mines and desulfurized using microorganisms. The pulverized coal can then be transported via pipelines using the new two technologies with intense slurry transportation. This assures coal transportation with high efficiency and low costs. Desulfurized coal can be distributed to and used at places including thermal electric power plants and homes, which will make a thorough measure against acid rain.

(4) The pipeline using the two new technologies can offer highly efficient and economic ways of transporting highly abrasive soil and sand by making it into intense slurry. Taking a construction of the Second Panama Canal for example, the employment of the pipeline using the two new technologies allows the construction period and cost to be reduced to one third respectively, making this a highly profitable business. Sludge accumulates in closed waters in the Tokyo Bay at their bottoms, where there is such a serious shortage of oxygen that benthic fish cannot maintain life. The sludge can be dredged and transported with intense slurry to the shore using the new technologies, and the sludge is given air at a water purifying plant where inorganic nutrient salt is fermented and decomposed. The discharging into the outer ocean ensures the richest fishing grounds in the world. The Tokyo Bay will become a clean ocean where benthic fish can live.

(5) An artificial island off the overseas coast is ideal as a place for industrial wastes, but it is disadvantageous because of its long transportation distance and high transportation cost. The transportation with a capsule transportation pipe using the two new technologies allows a construction at low costs. The eternal transportation pipe can be constructed in a short period of time, ensuring the low cost transportation.

1. A pipe joining method for correcting peaking comprising the following steps of:
1) bending a steel flat for a stiffening ring (3b) and a square bar for a lock ring (11) and a stop ring (15) with its bent butt portions undergoing end bending with a small radius of curvature;
2) bending each ring to a radius slightly smaller than that of the outer circumference of a steel pipe;
3) setting each ring with the weld portion of the steel pipe downside and its ring butt portion upside, a gap at the beveled butt portion varying depending upon the outside diameter of the steel pipe;
4) welding the rings at their beveled portions for attachment to the steel pipe;
5) inserting a pipe-expanding jack into the steel pipe to expand the steel pipe to such an extent as not to exceed the elastic limit of the rings in order to remove a gap appearing at both ends of the welded portion due to the peaking in the rings and the steel pipe, the rings being automatically welded downwardly during rotation of the steel pipe with the pipe-expanding force maintained; and
6) reducing the pipe-expanding force of the expansion jack to zero when the temperature of the welded portion is reduced to a certain level and then pulling the jack out of the pipe.

2. A pipe joining method for correcting peaking that appears on a joint ring (2) attached to an end of a steel pipe (1a) when the joint ring is manufactured at a factory by using flat steel made of ultra high tensile steel and bending it in a ring form, comprising the following steps of:
1) removing a lock ring (11) and a stop ring (15) from the pipe (1a) and cutting the inner surface of the pipe (1a) into which the joint ring is inserted;
2) inserting a pipe-expanding jack into the pipe (1a) to expand the pipe approximately 0.2% in inside diameter, then inserting the joint ring with the weld portion of the joint ring (2) circumferentially 90 degrees spaced from the weld portion of the lock ring, and returning the pipe-expanding force to zero to compress the inserted portion of the joint ring equally by the steel pipe (1a) with a compressive strain of 0.1 to 0.2% , thereby correcting peaking on the weld portion of the joint ring, wherein tensile steel is used for the lock ring so as not to undergo plastic deformation with the pipe expansion of 0.2%; and
3) automatically welding the fillet welded portion of the joint ring downwardly while the pipe (1a) is being rotated.

3. A pipe joining method for attaching a stiffening ring (3a) to a pipe (1b) comprising the step of:
1) gas cutting flat steel made of high tensile steel to the length of a claw (10);
2) roll bending the steel after end bending with its diameter made slightly smaller than the outer diameter of a stiffening ring (3b);
3) setting the bent stiffening ring to a bend jig for press working of the claw; and
4) arranging on the circumference of the bend jig several presses with their bending angle made greater gradually to bend the claw with one of presses sequentially in synchronism with the circumferential rotation of the bend jig, thereby bending the perpendicularly standing claw downwardly at 60 degrees;

5. A pipe joining method in which a packing (6) disposed between a joint ring (2) and a convex surface of a seal portion is impregnated with lubricating grease (7) to smooth the press fitting by a jack for improvement in sealing performance and the inner surface of the pipe is provided with a continuous lining to withstand frictional forces of fluid acting on the pipe wall and the lining material when the fluid flows in the pipe,
wherein the packing (6) is provided with countless fine projections at its tip (6a) and the inner surface of the pipe is provided with a continuous lining after press fitting with the fine projections on the tip of the packing biting into the fiber of a reinforcement sheet on the outer surface of the lining, thereby producing great shearing stresses as is the same with a sheet fastener to withstand the frictional forces of the fluid acting on the lining.

5. A pipe joining method comprising the steps of:
1) preparing a pipe with one end shaped as shown in (1a) and the other end as shown in (1b) at a factory and transporting it to the construction site where several hundreds to several thousands pipes are aligned straight whatever it may be long and they are press-fitted at once using a wire-traction jack;
2) defining the straight portion of the pipeline as one work section with both ends of the work section corresponding to a curved portion or a valve installing position, wherein centrifugal forces of the fluid act on the curved portion of the pipeline and inner pressures act on the straight portion thereof with the end of the pipe fixed to the ground via an anchor block;
3) arranging the pipes on jack-build-in rollers (16) at the straight portion of the pipeline;
4) arranging the jack-built-in rollers with the rollers spaced equally from each other at an interval equal to the pipe length, and raising the jack fully so that the upper surface of the rollers comes above the installation ground (19) to a level of the stop ring height (usually 60 mm) plus 20 mm;
5) increasing or decreasing sand (18) under the rollers to adjust the level and fixing one end of the traction wire (23) to the anchor block at the work section end with the other end of the wire fixed to the wire of a wire-traction jack (22) that is mounted on the last of the arranged pipes;
6) activating the wire-traction jack to slide the pipes on the rollers for press fitting with press-fitting forces acting on all the joints until their expansion or contraction gap C becomes zero, the return valve of the jack-build-in rollers being made open to lower the rollers to the ground level when the pipeline is thermally expanded to its maximum;
7) removing the level adjusting sand under the rollers and pulling the wire (23) to recall the rollers, water being caused to flow through the pipeline to lower the pipe temperature and contract the pipes with its expansion or contraction gap C made to a suitable one; and
8) disposing a spacer having a thickness corresponding to the thermal expansion between the stop ring and the stiffening ring for a case where hot water flows in the pipe and the pipe temperature is greater than when constructed, the spacer being removed after press fitting.

6. A pipe joining method according to a spread method, in which works are divided in such a manner that pre-work before press fitting by jack and post-work after press fitting by jack are completed at the same speed with workers and equipments arranged correspondingly.

7. A pipe joining method in which a seal portion has a convex surface (4) whose radius of curvature is so determined that even an angular displacement of the joint ring causes no compressive strain exceeding an allowable limit.
